(19) United States
(12) Patent Application Publication
(10) Pub. No.: US 2004/0020999 A1
(43) Pub. Date: Feb. 5, 2004

(54) Modular water fountain display

(76) Inventor: Noorolah Nader Beidokhti, Fountain Valley, CA (US)

Correspondence Address: ROY A. EKSTRAND, STE 150, 3158 REDHILL AVE, COSTA MESA, CA, 92626, US

(21) Appl. No.: 10/417,463

(22) Filed: Apr. 16, 2003

Related U.S. Application Data
(63) Continuation-in-part of application No. 10/124,935, filed on Apr. 18, 2002.

(51) Int. Cl. B05B 17/08

(52) U.S. Cl. 239/17

(57) ABSTRACT

A modular water fountain includes a support structure having an upwardly open concave water basin supported thereby. A center collector within the basin is further supported at the approximate center of the basin and receives a remotely controlled fountain unit. The fountain unit is capable of producing upwardly directed water spray displays as well as light and sound enhancement. A quantity of water is deposited within the basin and the center collector to provide water which is cycled through the fountain spray. In an alternate embodiment, the support apparatus for the basin is foldable between an open operating configuration and a closed non-operating transport or storage configuration.

### CROSS REFERENCE TO RELATED PATENT APPLICATIONS

This application is a continuation-in-part of co-pending application Ser. No. 10/124,935 filed Apr. 18, 2002 in the name of the applicant of this application, which related application is entitled IMPROVED BATTERY-POWERED REMOTELY CONTROLLED FLOATING POOL FOUNTAIN AND LIGHT APPARATUS and which is hereby incorporated herein by reference.

### FIELD OF THE INVENTION

This invention relates generally to fountains and other water display apparatus and particularly to those having aesthetic elements utilizing light patterns and colors and water spray combination and variation.

### BACKGROUND OF THE INVENTION

Fountains are perhaps one of the most well established and well known forms of aesthetic enhancement of many types of human habitation areas. It appears that from earliest recorded history that the development of dwelling construction and fabrication leading to larger and more permanent living structures and eventually to towns and cities included many types of fountains or water displays in one form or another. The variety of fountains or other types of water displays developed through the years is virtually endless. Such fountains have included the use of falling water and plumes utilizing natural water flow as well as spray type fountains employing appropriate pump and water conducting and control apparatus. In more complex fountain structures, a combination of naturally falling water plumes and cascades may be utilized to provide a dramatic aesthetic feature.

In addition to the virtually endless variety of falling water, cascades and spray water features utilized in fountains or other water displays, practitioners of the art have in more resent years endeavored to further augment and enhance the features within fountains and the like by utilizing illumination. The use of illumination in fountains typically involves focusing light which may be white or multi-colored upon selected portions of the moving water sprays or falling water cascades and plumes. The result is particularly dramatic in a dark night time environment in which the flowing water assimilates the color and brightness of the illumination.

Further enhancement and augmentation of fountains or other water displays has also included the use of sound accompaniment in the display or presentation. In more complex systems such as those known generically as “dancing water displays”, the fountain sprays and falling cascades or controlled or choreographed in combination with variations of illumination and sound accompaniment. Most often the sound accompaniment includes music of one form or another.

For the most part, fountains and other water displays have thus far been fabricated as generally fixed permanent structures which are not capable of easy movement or intended to be transported from one sight to another. Other fountains and water displays have been fabricated to float within environments such as swimming pools, reflecting ponds or other captive water.

Despite the extensive and long term development of fountains and water displays indulged in by practitioners in the art, there remains nonetheless a continuing and unfilled need in the art for evermore improved, interesting and amusing fountains and water displays. There remains a further continuing and unfilled need in the art for improved fountains and water displays which are more conveniently used and more conveniently erected in a variety of host environments.

### SUMMARY OF THE INVENTION

Accordingly, it is a general object of the present invention to provide an improved water fountain display. It is a more particular object of the present invention to provide an improved water fountain display which is modular in structure and which is more readily established within a selected environment. It is a still more particular object of the present invention to provide an improved modular water fountain display which may be readily moved between environments and which may be virtually portable.

In accordance with the present invention there is provided a self-contained modular stand-alone fountain display comprising a base supportable upon a support surface; a basin support supported by the base for receiving a quantity of water; an upwardly open concave basin having a center collector; and a fountain unit, received within the center collector having means for producing at least one fountain spray.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets a perspective view of a modular water fountain display constructed in accordance with present invention;

FIG. 2 sets forth a perspective assembly view of the major components of the present invention modular water fountain display shown in FIG. 1;

FIG. 3 sets forth a side elevation view of the center hub portion of the present invention modular water fountain display;

FIG. 4 sets forth a bottom view of the center hub of FIG. 3;

FIG. 5 sets forth a partially sectioned perspective assembly view of an alternate embodiment of the present invention modular water fountain display;

FIG. 6 sets forth a perspective view of a still further alternate embodiment of the present invention modular water fountain display;

FIG. 7 sets forth a partially sectioned perspective view of the present invention modular water fountain display shown in FIG. 6;

FIG. 8 sets forth a section view of an illustrative support and arm portion of the embodiment of the present invention water fountain display shown in FIG. 6;

FIG. 9 sets forth a side elevation view of the illustrative support and arm portion shown in FIG. 8 in its folded configuration;

FIG. 10 sets forth a section view of the support and arm of FIG. 9;

FIG. 11 sets forth an assembly view of the typical components of the illustrative arm and support shown in FIG. 10;

FIG. 12 sets forth a side elevation view of the embodiment of the present invention modular water fountain display shown in FIG. 6 in its alternative or folded configuration;

FIG. 13 sets forth a partial perspective view of the water flow apparatus of the fountain unit;

FIG. 14 sets forth a top view of a remote control unit used in the present invention;

FIG. 15 sets forth a block diagram of the remote control unit shown in FIG. 14;

FIG. 16 sets forth a perspective diagram of the additional music feature of the present invention modular water fountain display;

FIG. 17 sets forth a block diagram of the audio transceiver shown in FIG. 16; and

FIG. 18 sets forth a block diagram of the main controller operative within the pump unit of the present invention modular water fountain display.

### DESCRIPTION OF THE PREFERRED EMBODIMENTS

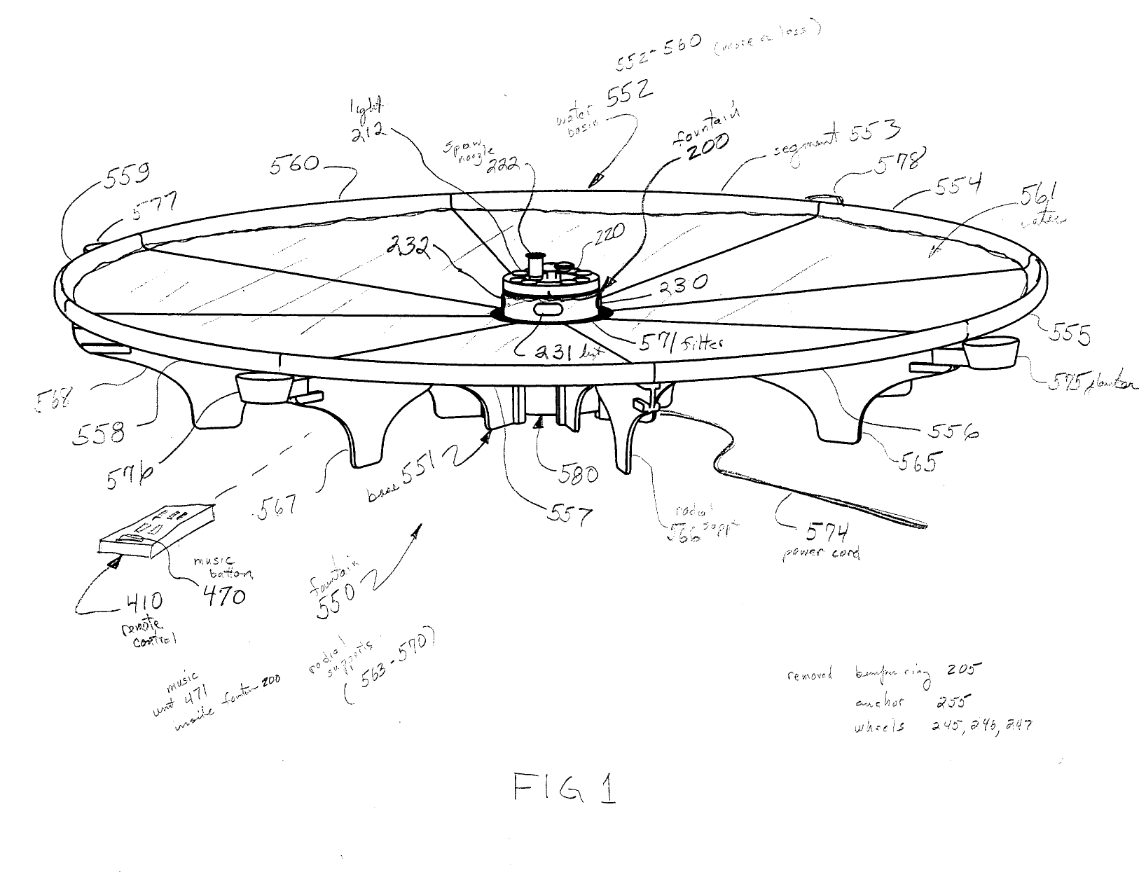

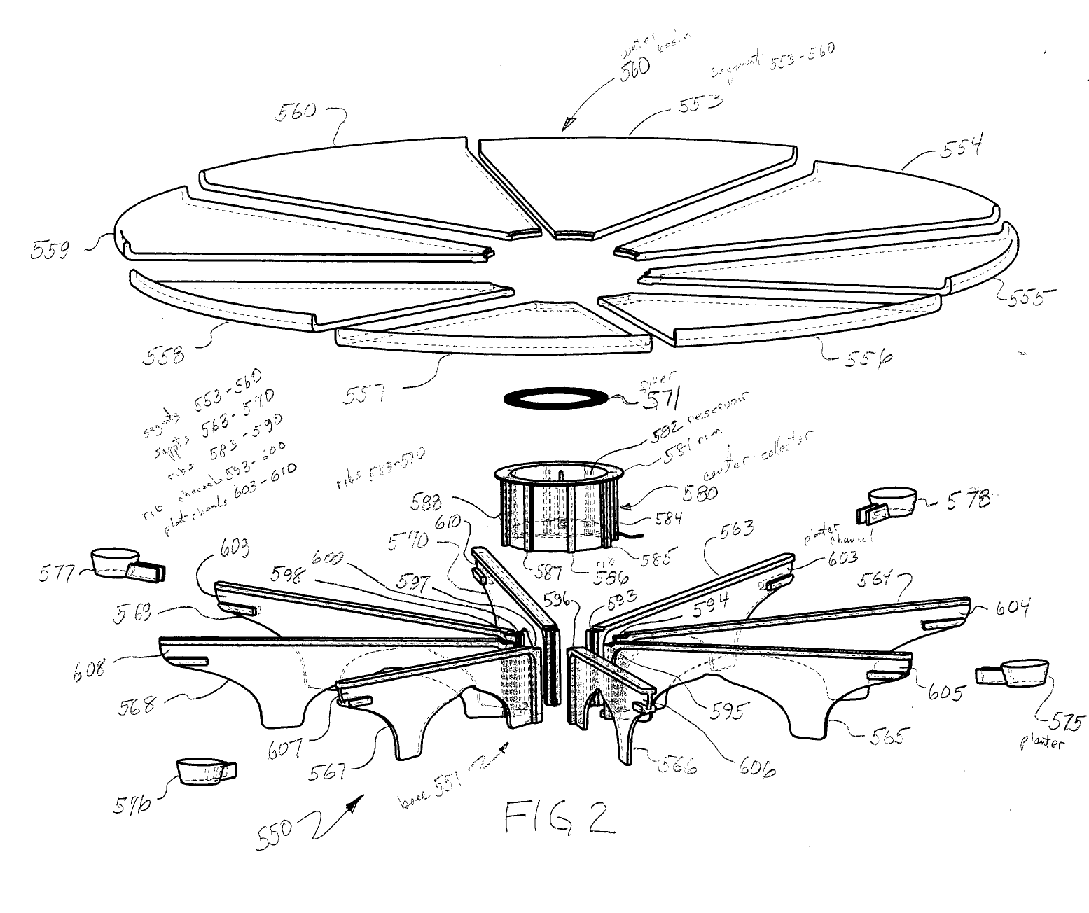

FIG. 1 sets forth a perspective view of a modular fountain constructed in accordance with the present invention and generally referenced by numeral 550. Fountain 550 is fabricated in a modular fashion allowing the entire fountain to be readily erected at a given environment and readily disassembled and moved should the need arise. Unlike other fountains which are established in heavy masonry or physically fixed environments, fountain 550 provides a stand alone fountain which may be utilized in virtually stable environment. Fountain 550 is comprised of several major elements including a water basin 552 having a generally circular shape and comprised of a plurality of joined circular segments 553 through 560. Segments 553 through 560 are formed to provide a upwardly facing concave water reservoir supporting a quantity of water 561 in an open free surface water body. In addition, modular fountain 550 includes a supporting base 551 which, as is better seen in FIG. 2 below, is fabricated of a generally cylindrical center collector 580 and a plurality of outwardly extending radial supports 563 through 570. In the preferred fabrication of the present invention, radial supports 563 through 570 extend outwardly from center collector 580 and are positioned beneath the abutting seams of each pair of segments 553 through 560. It will be noted that while basin 552 is shown fabricated using eight circular segments, for convenience ease of manufacture to accommodate a given basin size, different numbers of segments may be utilized without departing from the spirit and scope of the present invention. It will be further recognized that in the embodiment of the present invention shown in FIG. 1, basin 552 is generally circular in shape. However, it will be understood from the descriptions that follow that the present invention in no manner limited to a circular shape. The essential function of basin 552 is the collection of water from the center fountain unit as it returns downwardly following the spray process and thus virtually any shape water basin which is capable of collecting the descending fountain spray may be utilized without departing from the spirit and scope of the present invention.

An additional major component of modular fountain 550 includes fountain unit 200. Fountain unit 200 is fabricated in the manner described in the above reference co-pending patent application and is generally cylindrical in shape. Segments 553 through 560 define a center aperture which receives center collector 580. A return water filter 571 is positioned at the interior of segments 553 through 560. Further, fountain unit 200 defines a generally cylindrical shape conforming to collector 580 and is thus received therein in the manner shown in FIG. 1. The position of fountain unit 200 within basin 552 is selected to facilitate the extension of the upper portion of fountain unit 200 above the surface of water quantity 561.

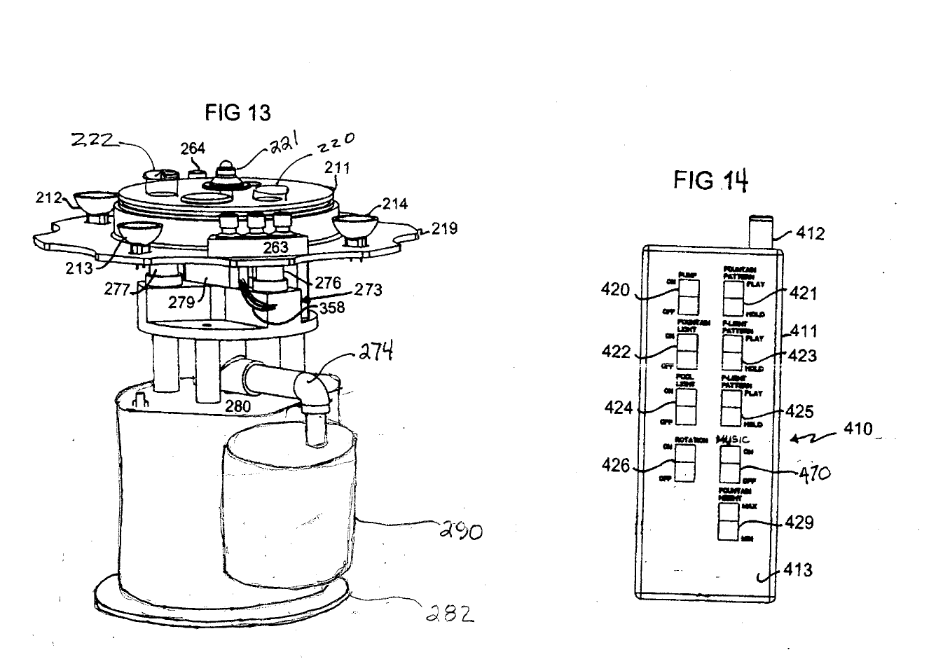

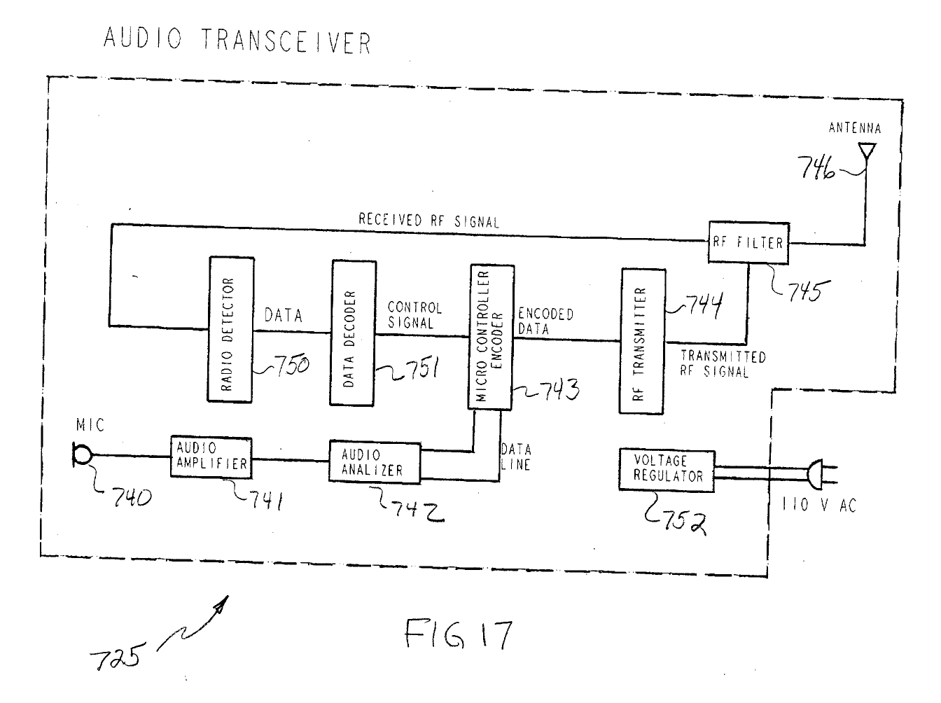

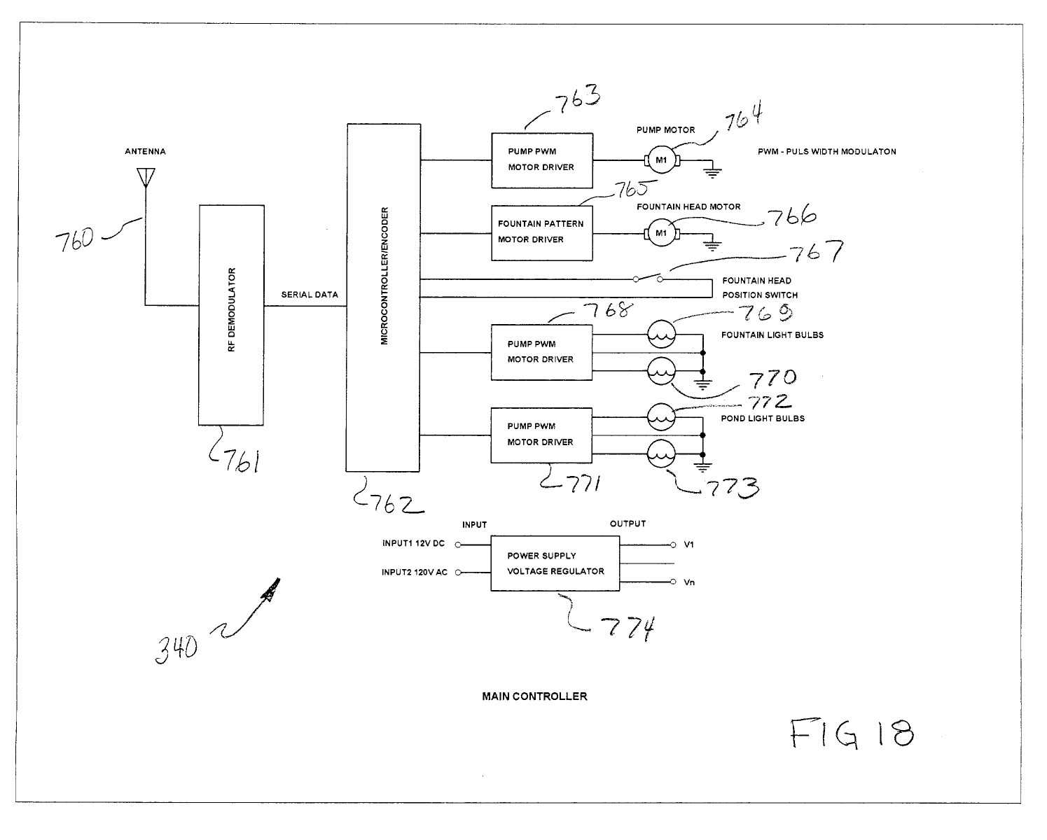

As mentioned, the fabrication and operation of fountain unit 200 is described in greater detail in the above referenced co-pending patent application. In addition, the pump and water flow portions of fountain unit 200 are described below and shown in FIG. 13. However, suffice it note here that fountain unit 200 includes a plurality of upwardly directed spray nozzles such as nozzles 220 and 221 together with apparatus for selectively pumping a quantity of pressurized water upwardly through one or more spray nozzles as desired. As is also described in great detail in the above referenced co-pending patent application, fountain unit 200 further includes a plurality of upwardly directed multicolored lights such as light 212. The use of lights within fountain unit 200 provides for entertaining and aesthetically pleasing coloration and illumination of fountain spray emulating from one or more of spray nozzles upon the upper surface of fountain unit 200. As is also described in the above referenced co-pending patent application, fountain unit 200 supports a plurality of multicolored lights along its cylindrical walls such as lights 230, 231 and 232. The function of sidewall lights 230, 231, and 232 is the illumination of the body of water 261 within basin 552. This illumination provides colored light or white light illumination of water 561 and provides further enhancement of the visual display provided by modular fountain 550. In further utilization of the apparatus in the above identified related patent application, a remote control unit 410 described fully in the above identified related patent application includes a communication link to responsive circuitry within fountain unit 210 (not shown) for controlling the operation of fountain spray nozzles and light apparatus within fountain unit 200. In further accordance with the present invention, remote control unit 410 is further augmented with a music command button 470. Music command button 470 activates the music synchronized operation of the present invention fountain set forth below in FIGS. 16 and 17. The basic operation of the music feature provides fountain spray variation and light actions which respond to music received from a near-by stereo or other audible music source.

The fabrication of fountain unit 200 utilizes the structure set forth in the above-identified related patent application which is also referenced as fountain unit 200 therein. The fountain unit set forth in the above-referenced related application in that the battery (battery 270), the anchor (anchor 255), the rotation motor and jet (motor pump 291 and jet 260), and the bumper ring (bumper ring 205) are omitted. In addition, the spacer system is also omitted.

But for these differences, the structure and operation of fountain unit 200 herein conforms to the above reference unit which is incorporated herein. Thus, FIG. 13 sets forth a perspective view of the assembly of the pump and water flow portions of the present invention fountain and light device. As described above, a bottom plate 282 supports a motor pump 290. Motor pump 290 is a DC motor pump which provides a flow of pressurized water to a coupling pipe 274 which supplies the upwardly directed fountain sprays of the present invention device.

A three-way water flow valve 273 is coupled to tee coupler 280 and pipe 274 and provides directional water flow coupling to couplers 276, 277 and 278. A support plate 219 is secured to actuator 279 of three-way flow valve 273 and further supports a plurality of colored lights 211 through 214 together with manual switches 263 and 264. The generally cylindrical housing of fountain unit 200 (seen in FIG. 1) supports a upper surface which in turn supports a plurality of upwardly directed fountain spray nozzles 220, 221, and 222. A plate 219 supported within the interior of the fountain unit housing supports a plurality of colored lights 210, 211, 212 and 213. A plurality of manually operated switches 263 and 264 are supported beneath the upper surface of the fountain unit housing.

Water pipe 274 extends upwardly from motor pump 290 and includes a coupler 280 which in turn is coupled to three-way valve 273. Valve 273 is operatively coupled to fountain spray nozzles 220, 221 and 222.

A plurality of light assemblies 230, 231, 232 and 233 (seen in FIG. 1) are further supported upon the outer housing of fountain unit 200. As described above, each of light assemblies 230 through 233 includes a respective light housing within which a plurality of colored lights are supported. While not seen in the figures, it will be apparent to those skilled in the art that a plurality of conventional wiring elements couple the light assemblies to an electronic control unit 340 which is supported within fountain unit 200 and shown in FIG. 18. Electronic control unit 340 is set forth below in FIG. 18 in greater detail. Suffice it to note here that control unit 340 provides the basic main controller function of the present invention fountain and light device.

Modular fountain 550 further includes a power connecting cord 574 which, in accordance with conventional wiring apparatus techniques (not shown) provides electrical connection to fountain unit 200. Within center collector 580, connective wiring (not shown) is supported and within conventional fabrication techniques provides operative power for fountain unit 200. In the preferred fabrication of the present invention, a transformer will be used to reduce the AC power to the lower voltage such as twenty four volts or twelve volts DC.

To further enhance the aesthetic appeal of modular fountain 550, a plurality of planters 575, 576, 577 and 578 are secured to radial supports 565, 567, 569 and 563. Planters 575 through 578 are fabricated to provide receptacles which may support one or more plant containers to provide added visual appeal for modular fountain 550. To provide enhanced flexibility, each of radial supports 563 through 570 define respective planter channels 603 through 610 (seen in FIG. 2) which slidably receive and retain selected planters such as planters 575 through 578. The simple sliding engagement of planters 575 through 578 allows a variety of planter numbers and locations to be utilized in efforts to maximize the visual presentation provided by modular fountain 555.

In operation, with modular fountain 550 assembled in the manner described below, a quantity of water 561 is deposited within basin 552 to establish the approximate water line shown in FIG. 1. A portion of the water within quantity 561 is allowed to flow downwardly through filter 571 to the interior of center collector 580. Thereafter, the user through activation of fountain unit 200 using remote control 410 activates the desired fountain spray operation within fountain unit 200. As a result, one or more upwardly directed fountain sprays are produced and water is pumped from the interior of collector 580 upwardly through spray nozzles within fountain unit 200 to produce the upwardly directed water spray. Thereafter, the water spray descends downwardly to be collected within water basin 552 and travels in a repeated cyclical process producing the desired fountain display. In addition, the operation of remote control unit 410 described in the above identified related patent application allows the user to select enhancement by activating one or more of lights 212 on the upper portion of fountain unit 200. Further, operation of remote control unit 410 may be utilized to also enable the desired colored of illumination from multicolor light sources 230, 231 and 232 upon the sidewalls of fountain unit 200. As mentioned above, the light sources on the sidewalls of fountain unit 200 are beneath the surface of water 561 and thus a further illumination of water 561 within water basin 552 is obtained. In further accordance with the present invention, the user may actuate music button 470 within remote control 410 which activates the music responsive light and fountain spray described below. As mentioned above, the entire structure and operation of fountain unit 200 as well as remote control 410 and the interaction therebetween is fully described in the above identified related patent application. Suffice it to note here that fountain unit 210 facilitates the operation of modular fountain 550 by producing the desired upwardly directed fountain spray activity and colored light illumination. It will be apparent to those skilled in the art that the use of fountain unit 200 and remote control 410 within modular fountain 550 are believed advantageous, other types of fountain units may be utilized within modular fountain 550 and supported within center collector 580 to produce operation of modular fountain 550.

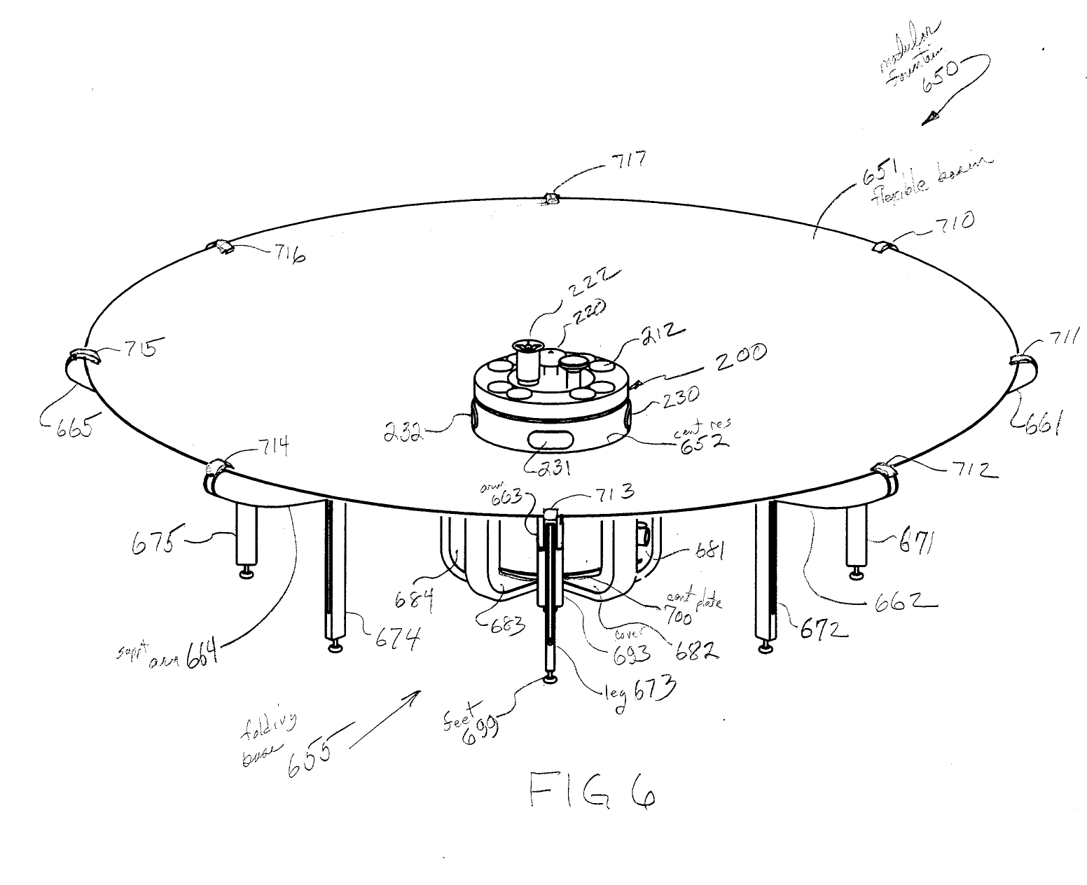

In accordance with an important aspect of the present invention, it will be noted that modular fountain 550 is fully self supporting and is assembled in the manner described below in greater detail to form a complete fully integrated modular fountain unit requiring nothing more than the application of a source of electrical power. Thus, modular fountain 550 may be assembled and erected in virtually any acceptable supporting sight upon virtually any surface. For example, modular fountain 550 may be integrated into a landscape arrangement or alternatively may be temporarily be positioned on a patio or pool deck for use in connection with a particular event or time period. Thereafter, the modular fountain may be emptied and disassembled for storage or use in a different environment. The important aspect with respect to the present invention is the lack of any need to fix or secure the modular fountain of the present invention to its supporting or surrounding surfaces. The fountain is stand alone and is not “built in” of necessity to secure its structure and operation. It will be further noted and as is set forth in the alternate embodiment of FIG. 5, that the assembly of water basin 552 using a plurality of circular segments is a matter of choice and convenience. Alternatively, a different of segments or indeed as is shown in FIG. 5, an entire one piece water basin may be used where appropriate without departing from the spirit and scope of the present invention.

FIG. 2 sets forth a perspective assembly view of modular water fountain 550 showing the assembly of water basin 560, center collector 580 and base 551 to form the modular fountain unit shown in FIG. 1. To avoid unnecessarily cluttering FIG. 2, fountain unit 200 and remote control unit 410 have been omitted from FIG. 2.

More specifically, water basin 560 is generally circular in shape and defines a center opening. Water basin 560 is fabricated of a plurality of circular segments 553 through 560. Segments 553 through 560 are joined along their respective junctions with associated segments using conventional fabrication techniques such as temporary adhesive, permanent adhesive, or fasteners (not shown) as desired. When segments 553 through 560 are fitted together and joined to form water basin 560, a concave upwardly open water reservoir is formed defining an outer rim and a center aperture.

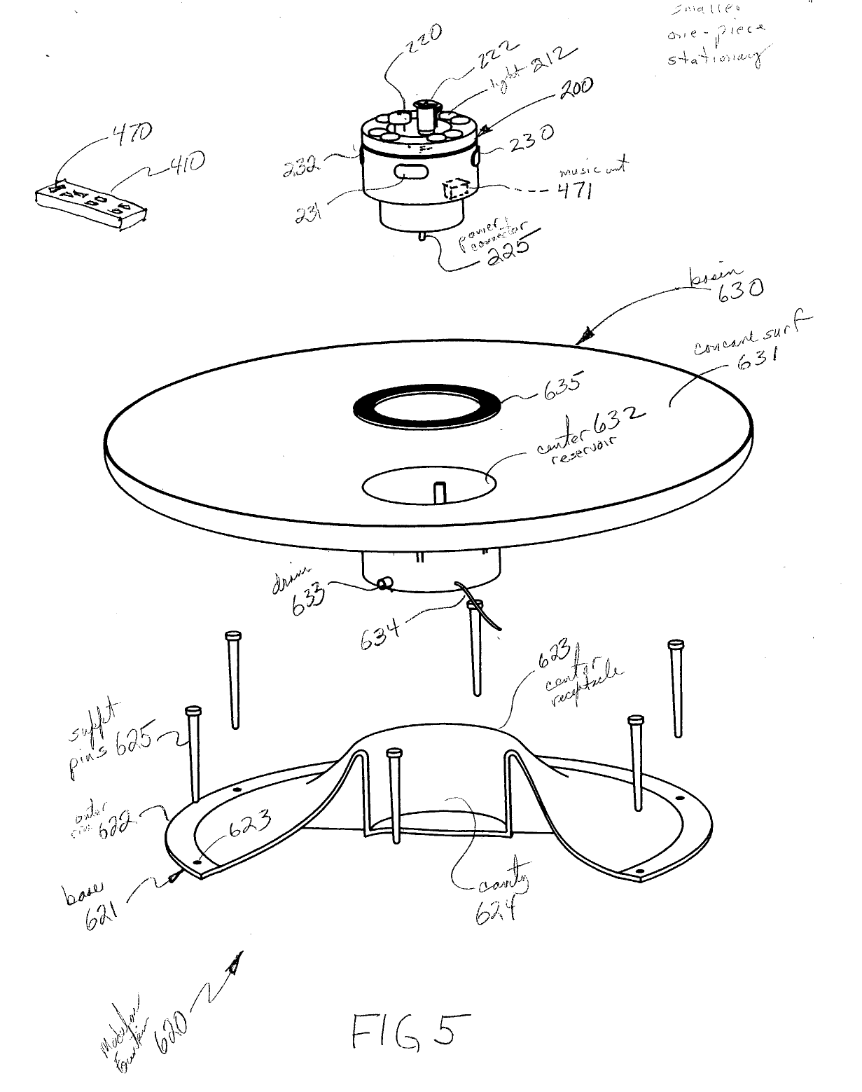

A center collector 580 having a generally cylindrical body and defining an interior reservoir 582 having a closed bottom surface 571 (seen in FIG. 4) is preferably formed of a molded plastic material or the like. The outer surface of center collector 580 defines a plurality of equally spaced ribs 583 through 590 which receive a corresponding plurality of radial supports 563 through 570. Radial supports 563 through 570 are substantially identical in fabrication and each includes a center channel 593 through 600 respectively. Channels 593 through 600 receive ribs 583 through 590 respectively to secure radial supports 563 through 572 center collector 580. The resulting structure provides a center hub and a plurality of outwardly extending radial supports forming a rigid base 551. Radial supports 563 through 570 further define planter channels 603 through 610 respectively. Each of channels 603 through 610 may receive and support a corresponding planter such as planters 575 through 578.

With base 551 assembled by securing radial supports 563 through 570 to center collector 580, a complete support base 551 is formed. Support base 551 is sufficient is strength and rigidity to support the combined weight of water basin 560, fountain unit 200 (seen in FIG. 1), and a quantity of water 561 (also seen in FIG. 1). The completion of fabrication of water basin 560 is carried forward by joining segments 553 through 560 at each adjacent seam thereof. This attachment or joining of segments 553 through 560 may be carried forward utilizing conventional fasteners (not shown) or alternatively using conventional permanent or non permanent adhesives as desired. The essential function of assembling water basin 560 is completed by providing a water tight annular concave upwardly open basin in the manner shown in FIG. 1. It will be further apparent to those skilled in the art that the preferred assembly of water basin 560 is carried forward such that a water tight seal is formed between the interior circular edges of segments 553 through 560 and rim 581 of center collector 580. Further, in the preferred fabrication of modular fountain 550, each seam of adjacent segments 553 through 560 is positioned upon the upper edge of an underlying one of radial supports 563 through 570. This provides ease of attachment utilizing the upper support if, for example, fasteners are employed or alternatively in the event adhesives are utilized. Further, the position of radial supports between each seam created between adjacent segments provides the strongest possible support for basin 560.

Once the combined assembly of radial supports 563 through 570 and center collector 580 and water basin 560 is complete, fountain unit 200 (seen in FIG. 1) is then lowered into reservoir 582 of center collector 580. Filter 571 is positioned as shown in FIG. 1 and provides appropriate filtering of the water return into reservoir 582 during the above described operation. Suffice it to note here that in the completed modular fountain the flow of water downwardly into water reservoir 582 for pick up by the pumping apparatus of fountain unit 200 (seen in FIG. 1) ensures that debris of the type normally encountered in an outdoor environment and the like is not drawn into the pumping apparatus of fountain 200.

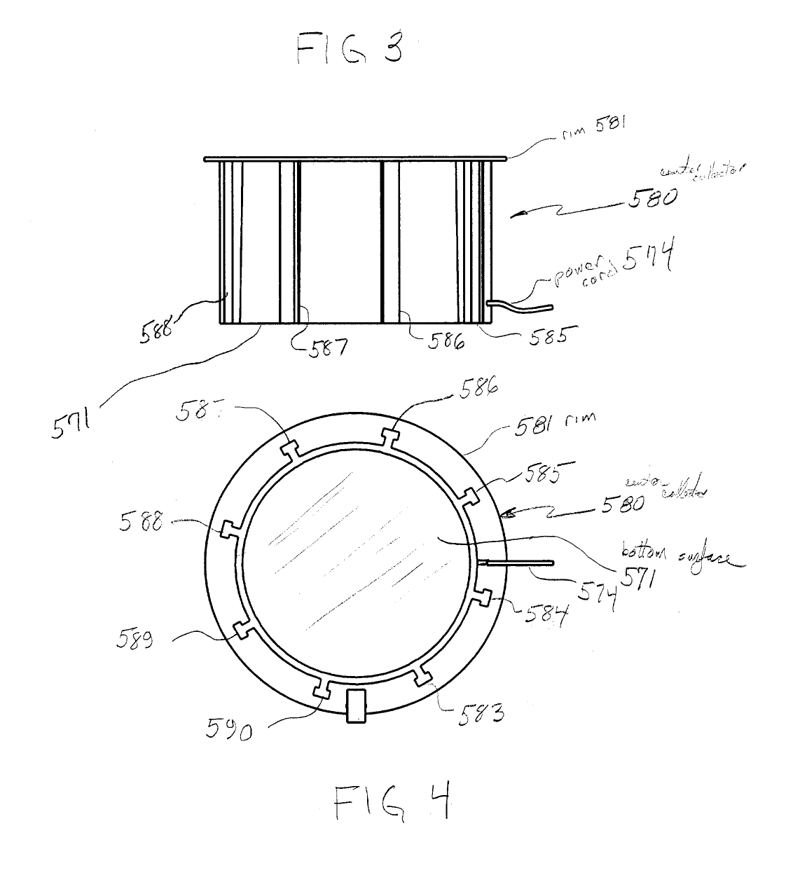

FIG. 3 sets forth a side elevation view of center collector unit 580. As described above, center collector 580 defines a generally cylindrical body having a plurality of outwardly extending evenly spaced ribs 583 through 590. As is also described above, ribs 583 through 590 slidably receive rib channels 593 through 600 (seen in FIG. 2) in a sliding attachment. A rim 581 encircles ribs 583 through 590 and extends outwardly from the upper surface of collector 580. A power cord 574 passes through an aperture formed in center collector 580 to communicate operative power to fountain unit 200 in accordance with conventional wiring techniques. While not seen in FIG. 3, it will be understood by those skilled in the art that the extension of power cord 574 through the wall of center collector 580 includes an appropriate seal to prevent water within the interior of center collector 580 from leaking out.

FIG. 4 sets forth a bottom view of center collector 580. As described above, center collector 580 is generally cylindrical in shape and defines a plurality of radially extending equally spaced ribs 583 through 590. As is also described above, a power cord 574 extends through the wall of collector 580. An annular rim 581 encircles the upper edge of collector 580 and a bottom surface 571 provides closure of collector 580 to provide water retention therein.

FIG. 5 sets forth a partially sectioned perspective assembly view of an alternate embodiment of the present invention modular water fountain display generally referenced by numeral 620. Modular fountain 620 differs from modular fountain 550 shown in FIGS. 1 through 4 in that a one piece base 621 together with a one piece fountain basin 630 is utilized in place of the multi element structures utilized in modular fountain 550 (seen in FIG. 1). In one sense, modular fountain 620 may, for example, accommodate a somewhat smaller sized modular fountain utilizing a fountain basin which is sufficiently small to be practical in its one piece fabrication. However, it will be recognized that basin 630 may be fabricated in a variety of sizes and shapes without departing from the spirit and scope of the present invention. Thus, basin 630 may, for example, be oval or multiply curved in shape or by way of further alternative, may be rectangular of square or faceted in shape such as hexagonal or octagonal without departing from the spirit and scope of the present invention. The circular embodiment shown in FIG. 5 is merely selected for purposes of illustration and should not be considered a limitation on the variety of fabrications of modular fountain 620 which fall within the scope of the present invention.

More specifically, base 621 includes an outer rim 622 having a plurality of apertures 623 formed therein. Base 621 further rises to a center receptacle 623 within which a generally cylindrical cavity 624 is formed. Basin 630 is fabricated of a single one piece fabrication and defines an upwardly open concave surface 631. A center reservoir 632 sized to fit easily within cavity 624 is formed continuously with concave surface 631. A drain aperture 633 and a power cord 634 are also shown extending outwardly from center reservoir 632.

In accordance with the above described fabrication of the present invention modular fountain, a fountain unit 200 fabricated in accordance with the fountain unit set forth in the above identified related patent application defines a generally cylindrical shape having a power connector 225 at the lower end thereof. The cylindrical sidewalls of fountain unit 200 further support a multicolored light assemblies 230, 231 and 232. In further accordance with the structure of fountain unit 200 set forth in the above identified related patent application, fountain unit 200 supports a plurality of upwardly directed lights 212 and a plurality of fountain nozzles such as fountain nozzles 220 and 222. In further improvement of fountain unit 200 and in accordance with an aspect of the present invention, a conventional sound producing unit 571 is supported within fountain unit 200.

Modular fountain 620 is assembled by initially positioning basin 630 upon base 621 such that center reservoir 632 extends downwardly into cavity 624. During this assembly, a plurality of support pins 625 are secured within apertures 623 upon outer rim 622. Pins 625 are configured and sized to support the underside of basin 630 and further stabilize basin 630 upon base 621. Thereafter, fountain unit 200 is positioned within center reservoir 632 and operatively coupled to power connecting cords 634 by conventional wiring techniques (not shown). Finally, a filter 635 is positioned upon fountain unit 200 to encircle the portion of fountain unit 200 which passes into center reservoir 632. At this point, fountain 620 is ready to receive a quantity of water which is collected upon concave surface 631 and within reservoir 632 of basin 630.

In accordance with the above described operation of modular fountain 550 shown in FIG. 1, fountain unit 200 utilized in modular fountain 620 also responds to remote control unit 410. Included in this response is the optional activation of sound and music synchronization of light and fountain sprays in response to activation of music button 470.

In operation, modular fountain 620 functions in the manner described above for modular fountain 550 in that a quantity of water within basin 630 is continuously pumped upwardly from center reservoir 632 to produce one or more fountain sprays at upwardly directed nozzles such as nozzles 220 and 222. In addition, and in response to remote control unit 410, multicolored illumination of the water within basin 630 may be provided by activating one or more of multicolored light units 230, 231 and 232. Further, and in further response to remote control unit 410, the fountain display provided by upwardly directed nozzles such as nozzles 220 and 222 may be further enhanced by selective illumination of one or more of the upwardly directed lights such as light 212 upon fountain unit 200. Finally, in response to activation of music button 470 on remote control unit 410, a transceiver described below is operative to provide appropriate enhancement of fountain sprays and light to receive external music. The water flow cycle within modular fountain 620 provides that water is cyclically pumped from center reservoir 632 upwardly through one or more of the nozzles within fountain unit 200 and thereafter collected within basin 630 and ultimately returned to center reservoir 632.

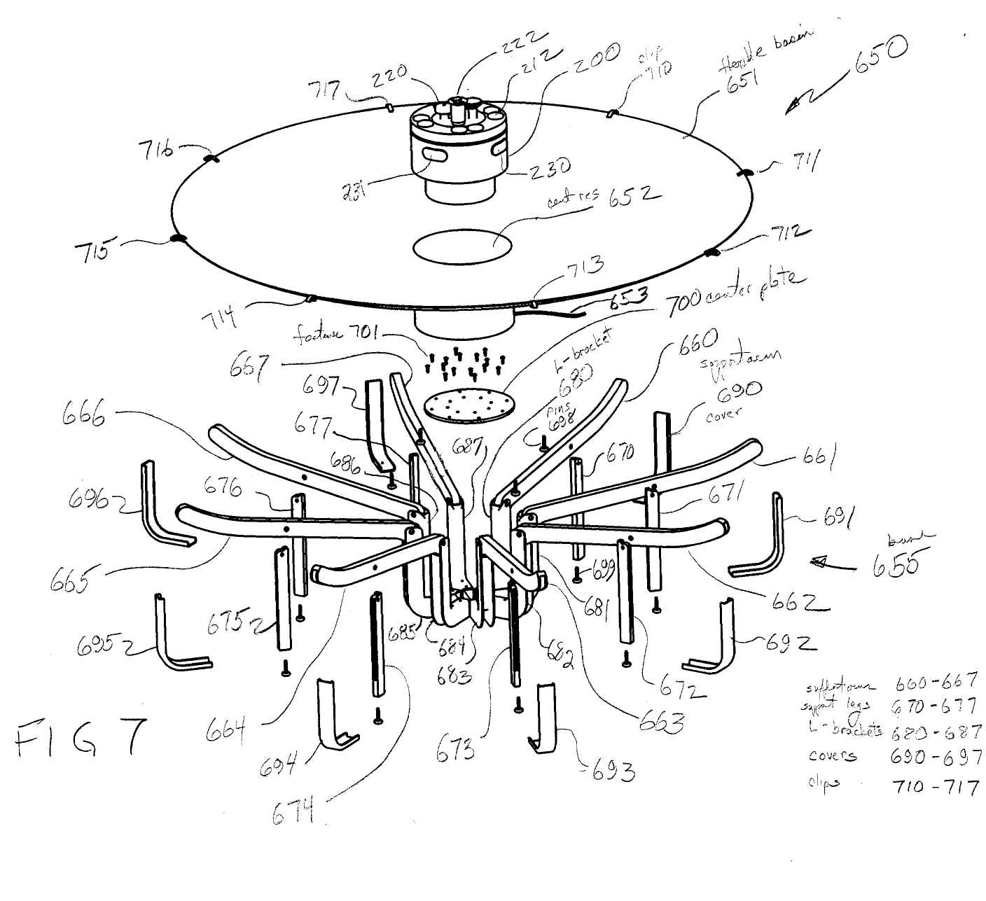

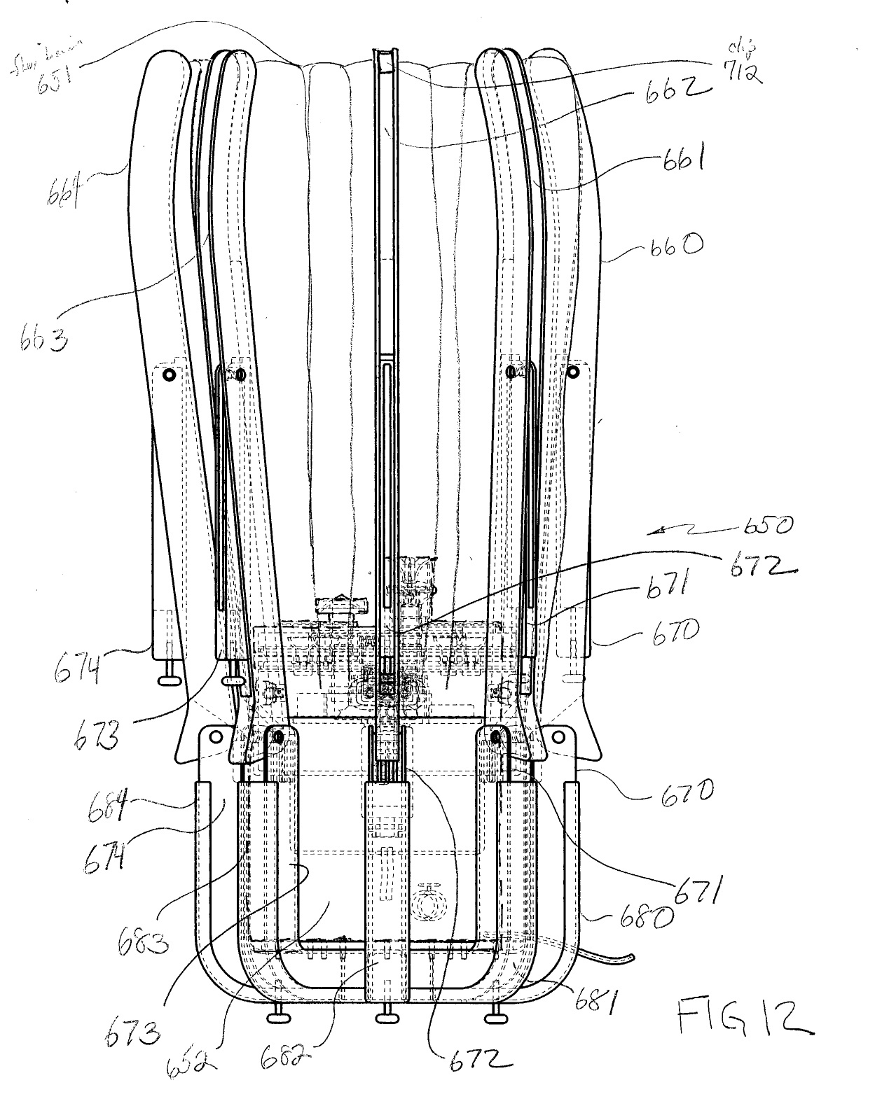

FIG. 6 sets forth a perspective view of a still further alternate embodiment of the present invention which as is described below differs from the previous embodiments in that it is not only modular but is also portable and may be folded from the extended configuration shown in FIG. 6 to the retracted configuration shown in FIG. 12. By way of overview, the embodiment set forth in FIG. 6 replaces the rigid basins found in the previous embodiments (basin 560 shown in FIG. 1 and basins 630 shown in FIG. 5) with a flexible water basin supported by a folding frame apparatus.

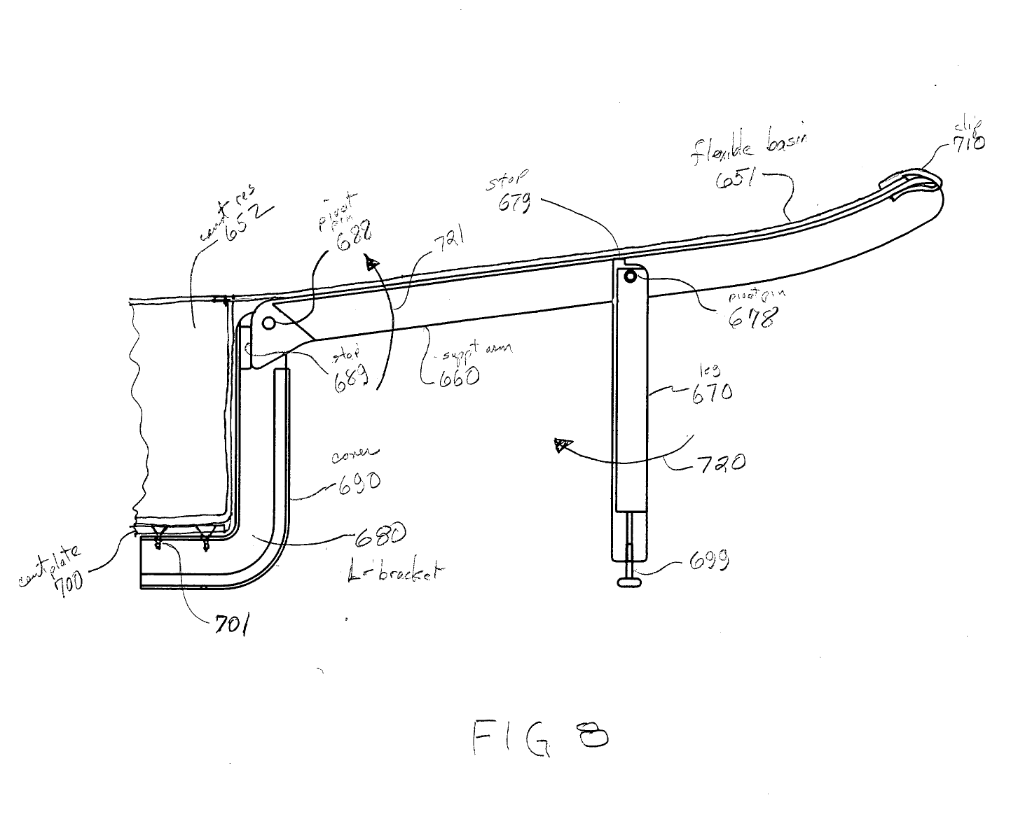

More specifically, modular fountain 650 includes a flexible fabric water repellent basin 651 supported by a folding base generally referenced by numeral 655. Flexible basin 651 is generally circular in shape in accordance with the embodiment shown in FIG. 6. However, it will be apparent to those skilled in the art that flexible basin 651 and folding base 655 may be configured in alternative shapes such as oval, faceted, rectangular or square without departing from the spirit and scope of the present invention. Flexible basin 651 defines a center reservoir 652 which, as is better seen in FIG. 7, extends downwardly from the center portion of the remainder of basin 651. Of importance with respect to the present invention is the realization that a water tight seal exists between center reservoir 652 and the corresponding mating edge of flexible basin 651. A fountain unit 200 fabricated in the manner described above in the above-mentioned related patent application includes upwardly directed spray nozzles such as nozzles 220 and 222, upwardly directed lights 212 and a plurality of multi-color sidewall light units 230, 231 and 232. While not shown in FIG. 6, it will be anticipated that a quantity of water is poured into and retained by the concave structure of flexible basin 651 as well as center reservoir 652.

The structure of folding base 655 is set forth below in FIG. 7 in greater detail. Suffice it to note here that folding base 655 is shown in FIG. 6 in its extended configuration and includes a center portion formed of a plurality of L-brackets such as brackets 681 through 684 shown in FIG. 6. A plurality of radially extending support arms are secured to corresponding L-brackets to extend outwardly beneath flexible basin 651 in the manner also shown below in FIG. 7 in greater detail. Further, each support arm is correspondingly supported near its midpoint by a retractable downwardly extending support leg. In FIG. 6 due to the perspective view therein, support arms 661, 662, 663, 664 and 665 are seen extending outwardly beneath flexible basin 661. With temporary reference to FIG. 7, it will be noted that a total of support arms 660 through 667 are evenly spaced and radially directed from the center portion of base 655. Correspondingly, a plurality of support legs such as legs 671, 672, 673, 674 and 675 each having respective supporting feet 669 extend downwardly from their respective arms such as support arms 661 through 665. Once again with temporary reference to FIG. 7, it will be seen that each support arm includes a corresponding support leg. A plurality of snap-fitting clips are secured to the outer ends of each of the support arms within folding base 655. As is better seen in FIG. 8, the function of support clips 710 through 717 is to provide a secure attachment of the outer edge portion of flexible basin 651 to the supporting structure of folding base 655.

In operation with a quantity of water supported within flexible basin 651 and center reservoir 652, the user is able to operate fountain unit 200 in the above-described manner to produce the desired fountain spray and light operation. Thus, modular fountain 650 in its extended configuration as shown in FIG. 6 operates in essentially the same manner as modular fountain 550 described above in FIG. 1 with the difference being found in its portability and capability of being folded between the extended position shown in FIG. 6 and folded position shown in FIG. 12.

FIG. 7 sets forth a perspective assembly view of modular fountain 650 showing the assembly of supporting elements within folding base 655. As described above, modular fountain 650 includes a flexible basin 651 having a center reservoir 652 formed therein. As is also described above, modular fountain 650 includes a foldable base 655 and a fountain unit 200.

More specifically, flexible basin 651 is preferably formed of a flexible waterproof fabric and is joined to a generally cylindrical downwardly extending center reservoir 652. A fountain unit 200 described above in the above-referenced related patent application is positioned for assembly within center reservoir 652.

Base 655 is formed of a plurality of radially extending foldable elements; the detailed structure of which is shown more clearly in FIG. 8. Suffice it to note here that base 655 includes a plurality of L-brackets 680 through 687 arranged in a generally radial evenly spaced configuration. A generally circular center plate 700 having a plurality of apertures formed therein is placed upon the lower center portion of the combination of L-brackets 680 through 687. Thereafter, a plurality fasteners 701 is utilized by passing through apertures within center plate 700 to engage underlying portions of L-brackets 680 through 687. The resulting subassembly of L-brackets 680 through 687 and center plate 700 together with fasteners 701 provides a rigid “bucket-like” receptacle for supporting center reservoir 652 and eventually a portion of fountain unit 200 during assembly. With L-brackets 680 through 687 assembled to center plate 700, a plurality of support arms 660 through 667 are pivotally secured to the upper ends of L-brackets 680 through 687 respectively by conventional pivot pins (such as pins 698). Once support arms 660 through 667 are pivotally secured to the upper ends of L-brackets 680 through 687, a correspondingly plurality of support legs 670 through 677 respectively are secured to the approximate midpoints of support arms 660 through 667 by conventional pivot pins such as pins 698. In addition, a plurality of supporting feet 699 are secured to the lower end of support legs 670 through 677 in the manner shown in FIG. 8. Finally, a plurality of L-shaped covers 690 through 697 are snap-fitted to the outer edges of L-brackets 680 through 687 respectively to complete the fabrication and assembly of base 655.

Once base 655 is fully assembly, flexible basin 651 is positioned upon support arms 660 through 667 and secured by clips 710 through 717 respectively in the manner set forth below in FIG. 8. Fountain unit 200 is then positioned within center reservoir 652 and is operatively coupled to a source of electric power using a power cord 653 and utilizing conventional wiring techniques (not shown).

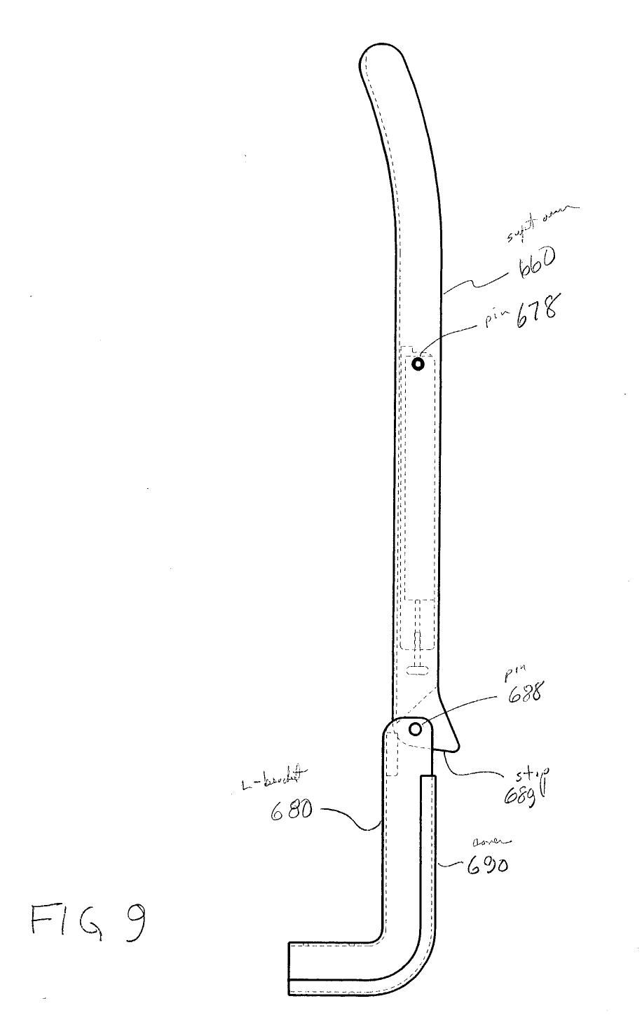

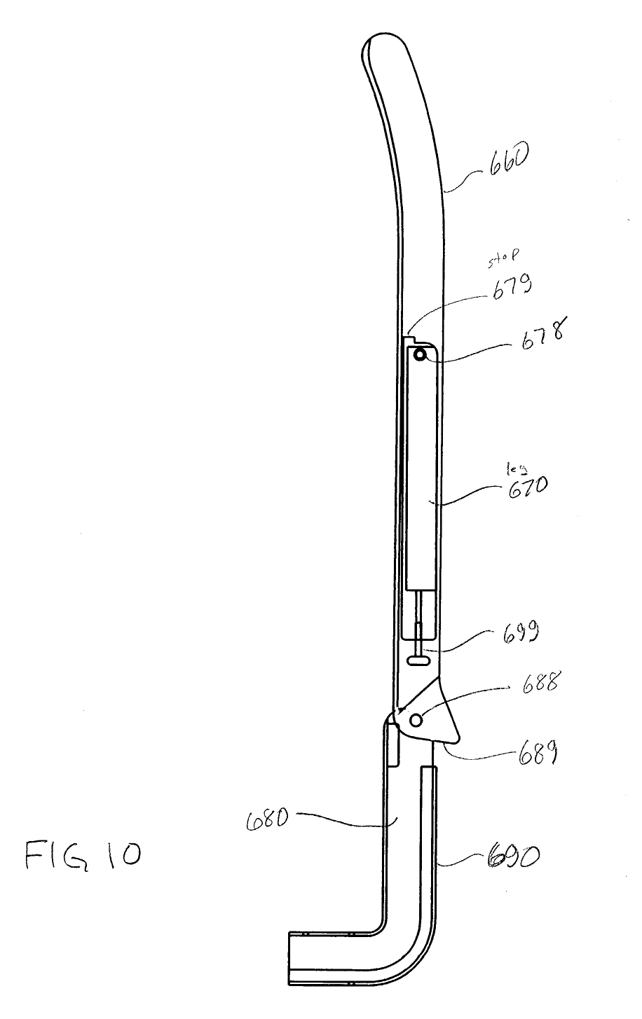

It will be apparent to those skilled in the art that the pivotal attachment of support arms 660 through 667 to the upper ends of L-brackets 680 through 687 facilitates extending support arms 660 through 667 in the manner shown in FIG. 7 or, alternatively, pivoting each arm upwardly to form the closed configuration shown in FIG. 2. When this folding occurs, flexible basin 651 remains attached by clips 710 through 717 and thus is also folded to generally enclose and extend upwardly about fountain unit 200. During folding, support legs 670 through 677 also pivot to retracted positions in the manner shown in FIGS. 9 and 10 below. In this manner, the entire structure of modular fountain 650 may be folded to the compact folded configuration shown in FIG. 12. Thereafter, modular fountain 650 may again be utilized by simply folding support arms 660 through 667 downwardly along with support legs 670 through 677 to the extended configuration shown in FIG. 6. In this manner, extreme ease of use, compact storage and complete portability is provided as an additional advantage to the present invention modular water fountain display.

FIG. 8 sets forth a section view of the support arm, support leg and L-bracket portion of base 655 within modular fountain 650 shown in FIG. 7. It will be apparent to those skilled in the art that the structure shown and descriptions which follow for FIG. 8 fully describe the combination of support arm 660, support leg 670, L-bracket 680 and cover 690 in a manner which is equally illustrative and descriptive of the remaining elements within base 655. Thus, with temporary return to FIG. 7, it will be apparent that base 655 is, in essence, a plurality of radially positioned sub-combination elements which are all identical to the structure shown in FIG. 8. Accordingly, the description of elements within FIG. 8 will be understood to apply equally well in understanding the remaining elements of base 655.

More specifically, support arm 660 includes a pivot pin 688 at its interior end and a clip 710 at its outer end. Support arm 660 defines a gently upwardly angled and upwardly curved shape extending outwardly from pivot pin 688. Accordingly, flexible basin 651 is secured to support arm 660 by clip 710 in a snap-fit attachment at its outer edge. Further, flexible basin 651 lies along and conforms to the general shape of the upper edge of support arm 660. L-bracket 680 extends downwardly from pivot pin 688 and inwardly beneath center plate 700 as described above. A plurality of fasteners 701 secure center plate 700 to the lower portion of L-bracket 680. A generally L-shaped cover 690 is snap-fitted to the outer portion of L-bracket 680 to provide a more complete structure and more pleasing appearance.

In the configuration shown in FIG. 8 which represents the extended position of support arm 66, support arm 66 has pivoted about pivot pin 688 to the generally horizontal position shown such that stop edge 689 abuts a portion of L-bracket 680 preventing further downward pivotal movement. Similarly, leg 670 pivotally secured to support arm 660 by pivot pin 678 assumes a generally vertical orientation and defines a stop member 679 which abuts the underside of the upper surface of support arm 660.

During the above-mentioned folding of base 655 (seen in FIG. 7) to the folded configuration shown in FIG. 12, support arm 660 is pivoted upwardly in the direction indicated by arrow 721 about pivot pin 688. Correspondingly, leg 670 is pivoted about pin 678 in the direction indicated by arrow 720 overcoming the resistance of stop 679. Stop 679 and the cooperating surface of support arm 660 deforms slightly to facilitate this pivotal movement of leg 670.

FIG. 9 sets forth the folded position of the support members shown in FIG. 8. In the upwardly folded configuration shown for support arm 660, support leg 670 and L-bracket 680, support arm 660 is pivoted about pin 688 causing stop 689 to move away from L-bracket 680. Correspondingly, support leg 670 is pivoted about pin 678 to its generally aligned position within the interior channel of support arm 660. As mentioned above, the operation of L-bracket 680, support arm 660 and support leg 670 is illustrative of the functioning of the remaining support arms, support legs and L-brackets set forth above which form base 655 (seen in FIG. 7).

FIG. 10 sets forth a section view of the structure of FIG. 8 showing the folded configuration of L-bracket 680, support arm 660 and support leg 670. As shown, support arm 660 is generally aligned with the upwardly extending portion of L-bracket 680 and is pivoted about pivot pin 688. Correspondingly, leg 670 is pivoted about pivot pin 678 to position leg 670 within the interior channel of support arm 660. Foot 699 is carried by and supported by leg 670. Cover 690 is snap-fitted to bracket 680 in the above-described manner.

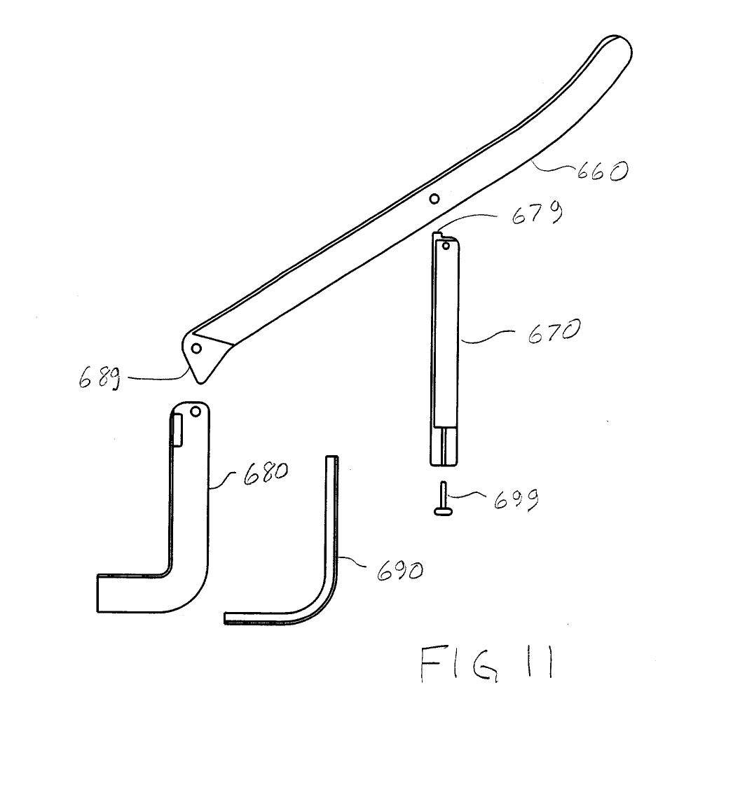

FIG. 11 shows a sectioned assembly view of the components set forth above in FIG. 10. Accordingly, L-bracket 680 receives cover 690 and is pivotally secured to support arm 660. Support arm 660 includes a stop edge 689 and further supports a support arm 670 which includes a stop member 679. A supporting foot 699 is received upon the lower end of leg 670 and is secured thereto by conventional threaded attachment (not shown).

FIG. 12 sets forth a side elevation view of modular fountain 650 in the folded or portable configuration. As described above, fountain 650 includes a center portion formed by a plurality of radially arranged L-brackets 680 through 687 (seen in FIG. 7). In the side elevation view of FIG. 12, L-brackets 670, 671, 672, 673 and 674 are visible showing their radial arrangement. Also shown in FIG. 12 are corresponding cover elements 680 through 684 respectively. In the folded configuration of FIG. 12, support arms 660 through 667 (seen in FIG. 7) are pivoted upwardly in general alignment with the vertical orientation of the upper portions of L-brackets 680 through 687 (also seen in FIG. 7). In this upwardly pivoted direction, a folded configuration of flexible basin 651 occurs. The attachment of support arms 660 through 667 is maintained in either the unfolded or folded configuration by the corresponding plurality of clips 710 through 717 (seen in FIG. 7). Accordingly, in the side elevation view of FIG. 12, the upward orientation of support arms 660, 661, 662, 663 and 664 is shown enclosing flexible basin 651 in a folded configuration. In essence, the action of support arms and flexible basin 651 of modular fountain 650 in folding and unfolding is somewhat similar to a fabric umbrella of the folding or foldable variety.

Also within FIG. 12, the position of center reservoir 652 within the arrangement of L-brackets is shown. As mentioned above, reservoir 652 receives fountain unit 200 and provides a water collecting reservoir for action in the cycling of water through pump unit 200 upwardly in spray patterns and downwardly for collection within basin 651. In the closed configuration shown in FIG. 12, of course, the fountain apparatus is not intended to operate and the quantity of water supported within basin 651 has been drained off prior to configuring modular pump 650 in its folded position. As will be apparent to those skilled in the art, the folded configuration of modular fountain 650 provides an extremely compact and easily transported or stored configuration. The general space occupied by modular fountain 650 in its folded or closed configuration corresponds roughly to the space occupied by a correspondingly scaled potted plant or the like.

It will also be noted that with support arms folded upwardly, the respective pivotally supported support legs are pivoted downwardly into the internal channels of their respective support arms. This provides a further compact character to the folded modular fountain. Modular fountain 650 may be easily returned to the open configuration shown in FIG. 6 by simply pivoting each of support arms 660 through 667 (seen in FIG. 7) downwardly about their respective L-bracket pivot supports to the configuration shown for support arm 660 in FIG. 8. Once the support arms have been pivoted downwardly, legs 670 through 677 (seen in FIG. 7) are also pivoted downwardly to the position shown in FIG. 8 to provide support beneath the respective support arms. The downward pivotal movement of support arms 660 through 667 to the position shown in FIG. 6 also unfolds flexible basin 651 to provide the upwardly open concave surface required for fountain operation.

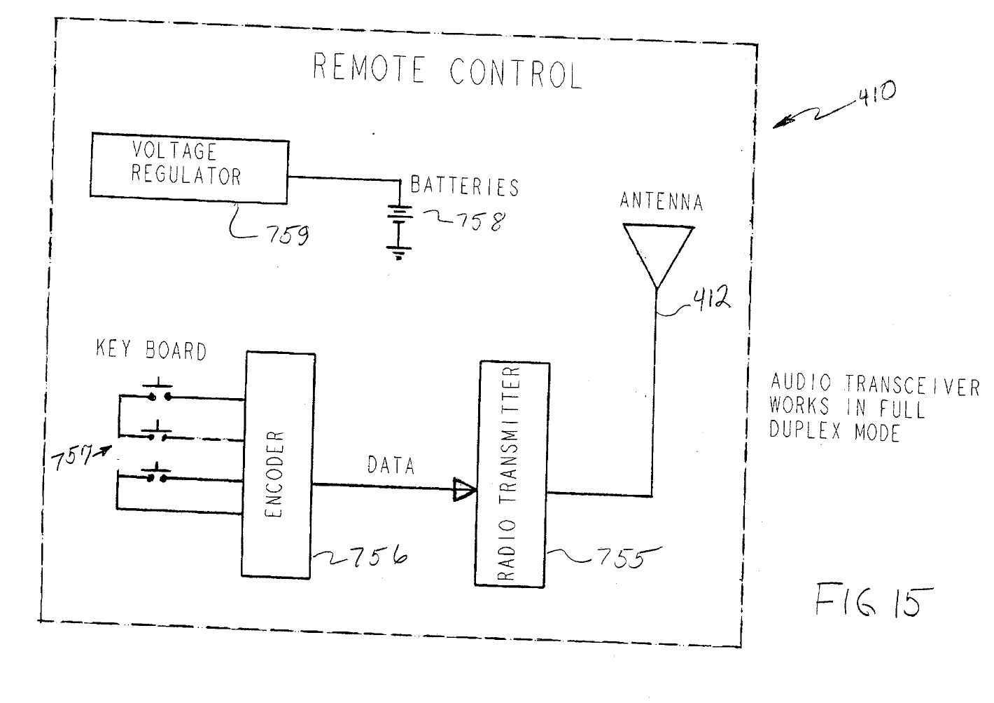

FIG. 14 sets forth the remote control unit constructed in accordance with the present invention and for use in combination with the present invention floating pool fountain and light device which is generally referenced by numeral 410. Control unit 410 is operative in combination with electronic control unit 340 (seen in FIG. 18). Electronic control unit 340 includes a further plurality of connecting wires which are coupled to three-way water flow valve 273 (seen in FIG. 13). Additional connections are provided for electrical connection within the present invention device to form the operative circuit set forth below in block diagram form in FIG. 18.

Returning to FIG. 14, remote control unit 410 includes a housing 411 and a transmitting antenna 412 both constructed in accordance with conventional fabrication techniques. Housing 411 includes a front face 413 upon which a plurality of switches 420 through 426 together with switches 429 and 470 are supported. It will be apparent to those skilled in the art that the fabrication of remote control unit 410 and the cooperating electronic control unit 340 (seen in FIG. 18) is carried forward utilizing conventional remote control transmission receiving and decoding apparatus. In the preferred fabrication of the present invention, the remote control transmission mechanism utilized is that of radio frequency signals. However, it will be equally apparent to those skilled in the art that other communication methods such as inferred without departing from the spirit and scope of the present invention. The important function of control unit 410 in cooperation with electronic control unit 340 is the communication of control signals as the result of user manipulation of switches 420 through 426, 429 and 470 to provide configuration and operation of the various apparatus operative within the present invention fountain and light device.

More specifically, surface 413 supports a variable speed pump on/off switch 420. This switch function to allow the user to remotely turn the spray fountain apparatus of the present invention on or off as desired. Utilizing switch 421, the user is able to select the spray pattern of the present invention fountain. When switch 421 is placed in the play position, the fountain will change the spray nozzle being utilized for a period of time and thereafter change to the next fountain nozzle and so on. Placing switch 421 in the hold position causes the present fountain nozzle to continue being used and maintains the current fountain spray pattern.

Switch 422 provides a on/off operation of the light mechanisms which illuminate the spray patterns utilizing lights 210 through 213 of fountain unit 200. Operation of switch 423 in the play position changes the colors of illumination of such lights in a given time sequence. Placing switch 423 in the hold positions maintains the current light color.

Switch 424 provides an on/off function for the pool lighting provided by pool lights 230 through 233 of fountain unit 200 which are supported about the center housing of the present invention fountain and light device. Switch 425 provides control signals which operate to choose the color of lights imparted to the water environment. With switch 425 placed in the play position, the color of bulbs within the light assemblies is periodically changed. Placing switch 425 in the hold position maintains the current light color.

Switch 429 is utilized in controlling the fountain spray height produced by the fountain nozzles of the present invention device. Moving switch 429 to the maximum position increases the height of fountain spray while moving switch 429 to the minimum position decreases the height of fountain spray.

Finally, moving music switch 470 to the on position activates the sound (music) synchronization feature of the present invention. This feature is described below in greater detail in connection with the FIGS. 16, 17 and 18. Suffice it to note here that this feature activates a transceiver which then responds to audio, such as music, from an external audio source, such as a radio or stereo, to control variations of fountain water spray and lights in synchronism with the music.

In the preferred fabrication the present invention, certain operational configurations are chosen in a default setting which operates in the absence of user provided remote control signals to the contrary. Thus, for example, the default setting of the light pattern for illumination of fountain spray which is controlled by switch 423 is the play mode in which colors vary over time. The default position for fountain spray pattern controlled by switch 421 is the play mode in which the fountain spray pattern changes periodically. Similarly, the default setting for the pool light pattern controlled by switch 425 is the play position in which the pool illumination colors vary from time to time. Music switch 470 is maintained in its off condition. In this manner, the basic operation of the present invention device is configured in the most likely favorable combination of settings as a “normal” or starting configuration from which the user may exercise control using remote control 410.

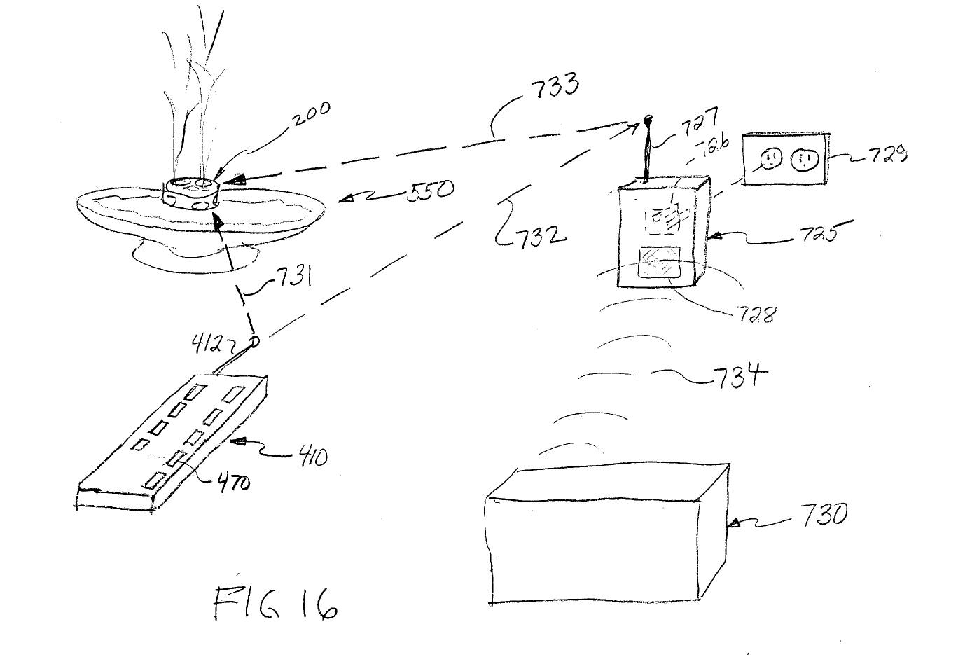

FIG. 15 sets forth a block diagram of remote control unit 410. Remote control unit 410 may be fabricated with conventional fabrication techniques. Thus, remote control unit 410 includes a transmitting antenna 412 coupled to a radio frequency transmitter 755. A keyboard 757 supports a plurality of user operated control inputs which are coupled to a data encoder 756. The output of encoder 756 is coupled to radio frequency transmitter 755. A plurality of batteries 758 are operatively coupled to the apparatus within remote control unit 410 and are further coupled to a voltage regulator 759.

In operation, the actuation of one or more control inputs on keyboard 757 produces a corresponding input data configuration for data encoder 756. The corresponding data which is defined by the input from the keyboard is coupled to the modulation input of a radio frequency transmitter 755. The data is then modulated within transmitter 755 upon an appropriate radio frequency carrier to produce a modulated radio frequency signal which is applied to antenna 412. The applied signal at antenna 412 is transmitted for communication to cooperating devices such as fountain unit 200 and transceiver 725 (seen in FIG. 16 below).

FIG. 16 sets forth a block diagram illustration of the music synchronization feature of the present invention fountain display. In accordance with the above described operation, a water fountain display 550 having a quantity of water supported therein and utilizing fountain and light unit 200 is supported together with a quantity of water therein. In further accordance with the above described apparatus, a remote control unit 410 is operative to control the operation of fountain unit 200 in response to actuation of one or more of the various operational controls supported upon remote control 410 in the above described manner. Thus, in the normal operation of the present invention modular water fountain display, the user actuates one or more of the control buttons upon remote control 410 producing a radio frequency signal at antenna 412 thereof. This radio frequency signal indicated by reference numeral 731 is transmitted to the corresponding receiving apparatus within fountain unit 200 (seen in FIG. 18). This corresponds to the typical operation of the present invention modular water fountain display.

However, in accordance with an additional feature of the present invention modular water fountain display, the user may actuate a music button 470 moving it to the on position described above in FIG. 14. In response thereto, remote unit 410 seizes communicating directly with fountain unit 200 and instead produces an output signal which is transmitted to a transceiver unit 725. Transceiver unit 725 is set forth below in FIG. 17 in greater detail. The operative apparatus within transceiver unit 725 include a conventional electrical plug 726 which is received within a conventional power outlet 729 of the type normally found in most homes and other buildings. Transceiver 725 further includes a transmitting antenna 727 responsive to the internal audio transceiver circuit (seen in FIG. 17). A microphone grill 728 is supported upon transceiver 725 and is proximate to an internal microphone (seen in FIG. 17).

An external source of sound such as music 730 is positioned proximate to transceiver 725 such that audible sound waves 734 propagate from unit 730 to transceiver 725. By way of example, sound unit 730 may comprise a portable radio, a conventional radio, a conventional stereo speaker system or other apparatus producing audible sound in sufficient strength and in sufficient proximity to transceiver 725 to actuate the audio responsive apparatus therein.

In response to incoming sound such as music or the like, the apparatus within transceiver 725 produces control signals which are transmitted from antenna 727 to the receiving system within fountain unit 200 as indicated by radio frequency communication path 733.

Thus, in operation, music such as sound or the like is communicated to transceiver 725 which in turn transmits control signals to the control apparatus within fountain unit 200. In the preferred operation of the present invention system, the activation of music button 470 of remote control unit 410 transfers operative control of the spray fountain apparatus and light control apparatus within fountain unit 200 from remote control 410 to transceiver 425. Thereafter, the control signals from transceiver 725 cause the fountain spray amplitudes and light operation of fountain unit 200 to be varied in synchronism with the predominant characteristic of the audio sound. Ideally, this sound characteristic corresponds to the “beat” or rhythm of the incoming music. In this manner, the operation of the present invention modular water fountain display is further enhanced by providing a “dancing water and light show” of the type previously found in more elaborate fountain and dancing water displays.

FIG. 17 sets forth a block diagram of audio transceiver 725. Audio transceiver 725 includes a regulated voltage source 752 coupled to a source of conventional house current. Voltage regulator 752 is operative in accordance with conventional fabrication techniques to convert the applied house current power to operative DC voltages of the characteristic utilized in powering the remainder of audio transceiver 725. Transceiver 725 includes a microphone 740 coupled to an audio amplifier 741 which in turn is coupled to an audio analyzer 742. The output of audio analyzer 742 is coupled to a microcontroller and encoder 743. Microcontroller 743 is coupled to a radio frequency transmitter 744 which in turn is coupled to a transmitting antenna 746 through a radio frequency filter 745. Audio transceiver 725 further includes a radio signal detector 750 coupled to filter 745 and further coupled to a data decoder 751. Decoder 751 is coupled to microcontroller and encoder 743.

In operation, the above-mentioned control signal produced by remote control 410 upon actuation of music button 470 (seen in FIG. 16) produces a radio frequency control signal which is received by antenna 746 and coupled by filter 745 to detector 750. Detector 750 recovers the modulated information on the control signal and applies it to data decoder 751. Decoder 751 responds to the encoded signal to provide a control signal which is applied to microcontroller and encoder 743. In response to the received control signal from remote control unit 410 (seen in FIG. 16), transceiver 725 responds to audible sound such as music or the like received and sensed by microphone 740. Microphone 740 converts the incoming sound energy to a corresponding electrical signal which is amplified by audio amplifier 741 and applied to audio analyzer 742. Analyzer 742 operates in accordance with an internal predetermined characteristic such as amplitude threshold or the like to produce a dominant signal characterizing the received sound. Ideally, this dominant characteristic would correspond to the beat or rhythm of music received by microphone 740. The output of audio analyzer 742 comprises control signals characterizing this dominant audible sound which are applied to microcontroller and encoder 743. Microcontroller and encoder 743 converts the output of audio analyzer 742 to encoded data which is modulated upon a suitable carrier signal by transmitter 744 to produce a radio frequency signal modulated with appropriate encoded data. The resulting signal is coupled by filter 745 to antenna 746 and is broadcast to fountain unit 200 (seen in FIG. 16). As mentioned above, fountain unit 200 responds to the control signals in a manner similar to the control signals provided by remote control unit 410 to operate the corresponding apparatus within the fountain unit to control light color and so on and to control fountain spray amplitudes and operation. The result is a “dancing water” and “light show” characteristic of operation.

The user is able upon deactivating music button 470 of controller 410 (seen in FIG. 16) to deactivate the music feature of the present invention by moving music button 470 to the off position. In the absence of the appropriate control signal received by audio transceiver 725, the transceiver seizes transmittal of the control signals and the operative control of the fountain unit again returns to the nominal settings therein and responds to the remote control unit.

FIG. 18 sets forth a block diagram of control unit 340 operative within fountain unit 200. Controller 340 includes a receiving antenna 760 coupled to a radio frequency demodulator 761. A microcontroller 762 is coupled to radio frequency demodulator 761 by a serial data line. A pump motor driver 763 is coupled to microcontroller 762 and is further coupled to a pump motor 764. Microcontroller 762 is further coupled to a fountain pattern motor driver 765 which in turn is coupled to a fountain head motor 766. A fountain head position switch 767 is mechanically coupled to the fountain head within fountain unit 200 and is operatively coupled to microcontroller 762. A pump motor driver 768 is coupled to a plurality of fountain light bulbs 769 and a further plurality of fountain light bulbs 770. A pump motor driver 771 is further coupled to microcontroller 762 and a plurality of basin light bulbs 772 and 773. Finally, a regulated power supply 774 is constructed in accordance with conventional fabrication techniques and is operative to provide the appropriate operating voltages for use within controller 340.

In operation, control signal received at antenna 760 from either remote control unit 410 or transceiver 725 (both seen in FIG. 16) are demodulated by radio frequency demodulator 761 to recover the encoded data modulated thereon. The recovered data is communicated to microcontroller 762 which responds in accordance with the stored program therein to activate one or more of pump motor drivers 763, 765, 768 or 771 to produce the desired operational effect within fountain unit 200 (seen in FIG. 1). It will be apparent to those skilled in the art that controller 340 may be fabricated in accordance with conventional fabrication techniques in which a controller circuit is responsive to remotely transmitted control signals.

What has been shown is a novel modular water fountain display having a plurality of differing embodiments which may all be characterized as providing an easy to assemble and easy to use stand-alone water fountain display. The water fountain display shown utilizes a novel multi-function fountain unit which provides a variety of spray patterns and light enhancements together with sound augmentation synchronization at the control of a remote control unit. In the most portable embodiment of the present invention modular fountain shown, the fountain module is configurable between an extended open configuration for use and a folded compact configuration to be utilized when the fountain is not in use which facilitates transport and storage of the fountain.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

That which is claimed is:

1. A self-contained modular stand-alone fountain display comprising:
a base supportable upon a support surface;
a basin support supported by said base for receiving a quantity of water;
an upwardly open concave basin having a center collector; and
a fountain unit, received within said center collector having means for producing at least one fountain spray.

2. The fountain display set forth in claim 1 wherein said center collector is generally cylindrical and extends downwardly into said base.

3. The fountain display set forth in claim 2 wherein said fountain unit includes remote control responsive means.

4. The fountain display set forth in claim 3 wherein said basin is generally circular.

5. The fountain display set forth in claim 4 wherein said basin is formed of a plurality of circular segments joined to form said basin.

6. The fountain display set forth in claim 4 wherein said basin is formed as a one-piece unit.

7. The fountain display set forth in claim 4 wherein said basin support is foldable between an open configuration and a closed configuration and wherein said basin is formed of a flexible material and said basin also folds between said open configuration and said closed configuration.

8. The fountain display set forth in claim 7 wherein said center collector is joined to said flexible material basin.

9. The fountain display set forth in claim 8 wherein said fountain unit includes sound producing means.

10. A self-contained modular stand-alone fountain display comprising:
a base supportable upon a supporting surface, said base including a basin support;
a basin having an upwardly open concave water supporting surface and a water collecting reservoir, said basin being supported by said basin support; and
a fountain unit having water spray means supported within said water collecting reservoir.

11. The fountain display set forth in claim 10 further including a remote control unit and wherein said fountain unit includes control means responsive to said remote control unit for changing the operation of said water means.

12. The fountain display set forth in claim 11 wherein said fountain unit includes sound-responsive means responsive to audible sound and producing control signals characterized by said audible sound and communicated to said control means for varying the operation of said water spray means in accordance with a portion of said audible sound.

13. The fountain display set forth in claim 10 wherein said base and said basin are configurable in an open configuration for operation and a closed configuration for storage and transport.

14. The fountain display set forth in claim 10 wherein said water spray means are at least partially influenced by an external source of audible sound.

15. The fountain display set forth in claim 11 further including means for receiving audible sound and producing audio control signals wherein said control means responds to said audio control signals, whereby music played by an external source are received by said means for receiving audible sound influences said water spray means.

16. The fountain display set forth in claim 11 wherein said fountain display includes a plurality of lights and wherein said control means includes means for varying the operation of said lights in response to music played by an external source which is received by said means for receiving.

17. The fountain display set forth in claim 1 further including a plurality of planters and wherein said basin support includes means for supporting said plurality of planters about the outer periphery of said basin.
